(19) United States
(12) Patent Application Publication
(10) Pub. No.: US 2016/0271931 A1
(43) Pub. Date: Sep. 22, 2016

(54) MULTILAYER GRAPHIC ARTS ROTATING SLEEVE

(71) Applicant: Universal Engraving, Inc., Overland Park, KS (US)

(72) Inventors: Larry R. Hutchison, Overland Park, KS (US); Eric A. Domsch, Olathe, KS (US)

(73) Assignee: Universal Engraving, Inc., Overland Park, KS (US)

(21) Appl. No.: 15/073,505

(22) Filed: Mar. 17, 2016

Related U.S. Application Data
(63) Continuation-in-part of application No. 14/689,935, filed on Apr. 17, 2015.
(60) Provisional application No. 62/135,022, filed on Mar. 18, 2015.

(51) Int. Cl. B41F 13/08

(52) U.S. Cl. CPC B41F 13/08

(57) ABSTRACT

A graphic arts sleeve includes a cylindrical plate presenting an outermost sleeve surface operable to engage and thereby texture, print, and/or hot foil stamp on a substrate. The cylindrical plate presents an innermost support surface opposite the outermost sleeve surface and operable to engage a mandrel. The cylindrical plate includes an intermediate carrier layer and an overlying engravable layer cladded to and supported by the carrier layer. The cylindrical plate further includes an underlying expansion layer cladded to the carrier layer. The expansion layer has a greater coefficient of thermal expansion than the carrier layer, with heating of at least the expansion layer causing diametrical expansion of the innermost support surface to facilitate mounting or removal of the cylindrical plate relative to the mandrel.

### RELATED APPLICATION

This application claims the benefit of U.S. Provisional Application Ser. No. 62/135,022, filed Mar. 18, 2015, entitled GRAPHIC ARTS ROTATING SLEEVE AND SUPPORT MANDREL, and also claims the benefit of and is a continuation-in-part of U.S. application Ser. No. 14/689,935, filed, Apr. 17, 2015, entitled GRAPHIC ARTS SLEEVE AND SUPPORT MANDREL, each of which is hereby incorporated in its entirety by reference herein.

### BACKGROUND

1. Field

The present invention relates generally to a rotary graphic arts sleeve system. More specifically, embodiments of the present invention concern a multilayer graphic arts rotating sleeve suitable for use in rotogravure printing, embossing, debossing, texturing, and/or hot foil stamping.

2. Discussion of Prior Art

It is known in the art for a rotary die to be used for graphic arts embossing and/or stamping of a substrate. For instance, conventional graphic arts systems include a solid cylinder mandrel supporting a die plate. It is known for a mandrel to support a bimetal die plate. Prior art systems are also known to include a mandrel with multiple metal die plates.

However, conventional rotary graphic arts systems have certain deficiencies. For instance, the cylinders and dies of known rotary press systems are expensive to build and maintain. Furthermore, conventional rotary press systems are time consuming and expensive to setup. Specifically, conventional systems throughout the industry use setup processes to position dies in precise registration with the substrate.

### SUMMARY

The following brief summary is provided to indicate the nature of the subject matter disclosed herein. While certain aspects of the present invention are described below, the summary is not intended to limit the scope of the present invention.

Embodiments of the present invention provide a multilayer graphic arts rotary sleeve that does not suffer from the problems and limitations of the prior art systems set forth above.

A first aspect of the present invention concerns a graphic arts sleeve operable to be removably mounted on a rotatable mandrel and to texture, print, and/or hot foil stamp on a substrate. The graphic arts sleeve broadly includes a cylindrical plate. The cylindrical plate presents an outermost sleeve surface operable to engage and thereby texture, print, and/or hot foil stamp on the substrate. The cylindrical plate presents an innermost support surface opposite the outermost sleeve surface and operable to engage the mandrel. The cylindrical plate includes an intermediate carrier layer and an overlying engravable layer cladded to and supported by the carrier layer. The cylindrical plate further includes an underlying expansion layer cladded to the carrier layer. The expansion layer has a greater coefficient of thermal expansion than the carrier layer, with heating of at least the expansion layer causing diametrical expansion of the innermost support surface to facilitate mounting or removal of the cylindrical plate relative to the mandrel.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is perspective of a rotary graphic arts assembly constructed in accordance with a preferred embodiment of the present invention, with the assembly including a press mandrel and a rotary sleeve;

FIG. 2 is an exploded perspective of the assembly shown in FIG. 1, showing end caps, screws, and a mandrel body of the press mandrel;

FIG. 3 is an enlarged fragmentary end view of the mandrel body shown in FIGS. 1 and 2, showing a longitudinal slot presented by the mandrel body;

FIG. 4 is a fragmentary end view of the assembly shown in FIGS. 1 and 2, showing a die plate and slide of the rotary sleeve, with the die plate including an engravable layer, carrier layer, expansion layer, and plating layer, and with the sleeve mounted to the press mandrel;

FIG. 5 is an enlarged fragmentary end view of the assembly shown in FIGS. 1, 2, and 4, showing the slide positioned in the slot of the press mandrel;

FIG. 6 is a fragmentary end view of a cladded plate which forms part of the rotary sleeve shown in FIGS. 1, 2, 4, and 5, showing an engravable layer, carrier layer, and expansion layer of the plate;

FIG. 7 is a fragmentary end view of the cladded plate similar to FIG. 6, but showing the plate after margins thereof have been machined to remove endmost portions of the engravable layer and the expansion layer and thereby expose the carrier layer;

FIG. 8 is a fragmentary end view of the plate shown in FIG. 7, but depicting the plate formed into a cylindrical shape so that the margins of the machined plate are adjacent to one another and cooperatively form a longitudinal seam;

FIG. 9 is a fragmentary end view of the curved plate shown in FIG. 8, showing a longitudinal channel cooperatively defined by the margins and receiving a slide therein and further showing a gap defined between margins of the engravable layer;

FIG. 10 is an enlarged fragmentary end view of the rotating sleeve similar to FIG. 9, but with a longitudinal weld being formed along the seam to weld the exposed carrier layer of the curved plate to the slide and thereby form the rotating sleeve;

FIG. 11 is a fragmentary end view of the rotating sleeve similar to FIG. 10, but showing filler material that has been deposited into and above the gap in the engravable layer to form a longitudinal bead; and

FIG. 12 is a fragmentary end view of the rotating sleeve similar to FIG. 11, but with the filler bead reduced so that the outer surface of the engravable layer presents a continuous diameter across the seam, with the outer surface of the engravable layer being configured to receive the plating layer.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

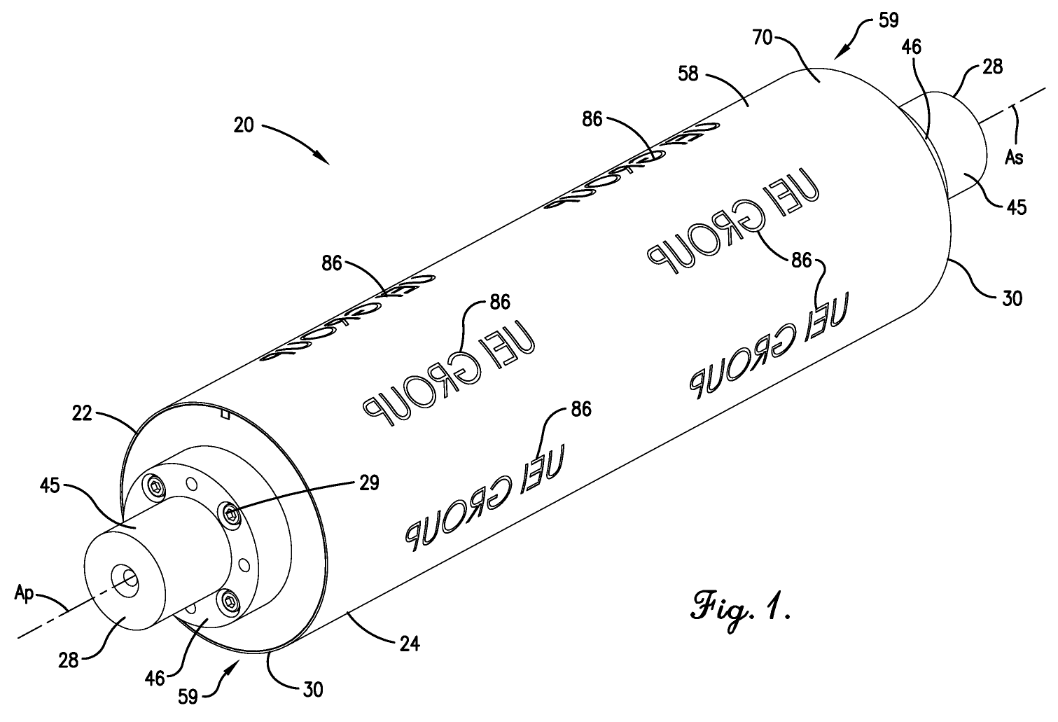

Turning initially to FIGS. 1-4, a rotary graphic arts assembly 20 is constructed in accordance with a preferred embodiment of the present invention. Preferably, the assembly 20 is employed in a method of texturing (such as embossing and/or debossing), printing, hot foil stamping, and combinations thereof and is utilized in connection with a rotary press (not shown) to texture, print, and/or hot foil stamp a substrate (not shown). As will be described, the assembly 20 preferably presents a curved image surface that corresponds with the image to be textured, printed, and/or hot foil stamped onto the substrate.

For instance, the assembly 20 can be used as part of a rotogravure process where the recessed regions receive ink that is transferred to the substrate to print a desired image. The assembly 20 can also be used in an emboss/deboss process to apply an embossed and/or debossed texture to corresponding regions of the substrate. When the assembly 20 is used for texturing, the image to be embossed and/or debossed may be formed by a relief surface that is effectively “raised” relative to a lower surface (which corresponds with the area removed during the image forming process, such as engraving). Alternative embodiments of the assembly can further be used in a hot foil stamping process to apply foil to corresponding regions of the substrate. Yet further, it is within the ambit of the present invention where the assembly is used to apply any combination of printing, texturing, and hot foil stamping to the substrate. It will also be appreciated that the illustrated assembly 20 is configured to texture, print, and/or hot foil stamp various sizes and/or types of substrate. The assembly 20 preferably includes a press mandrel 22 and a rotary sleeve 24.

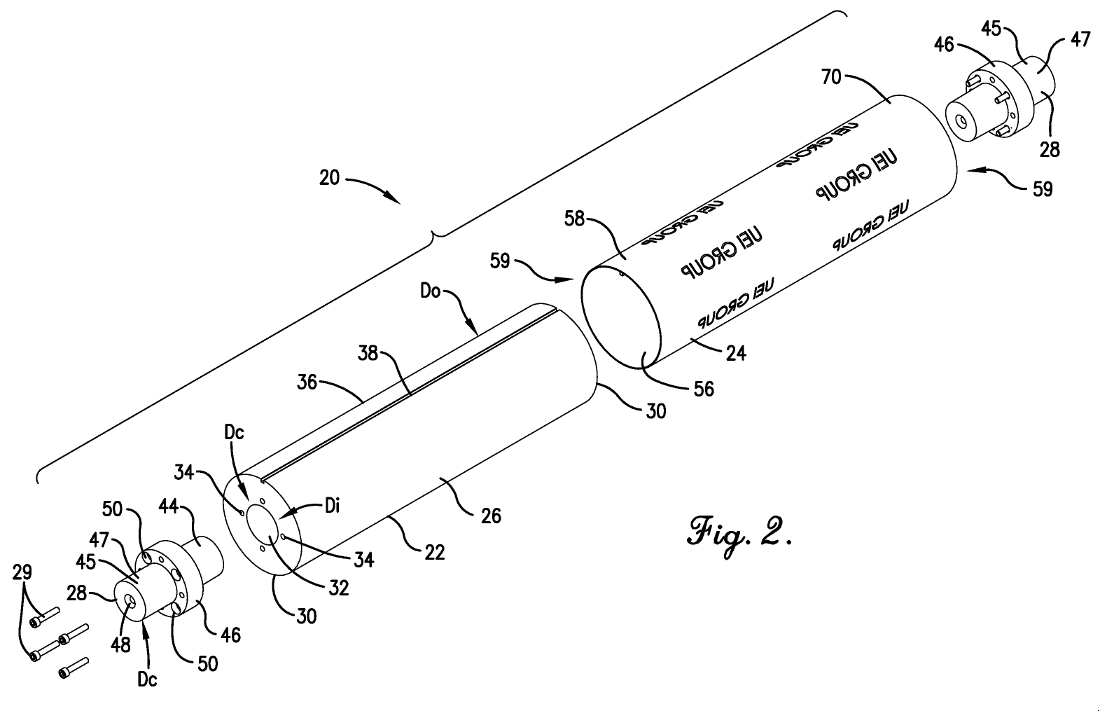

In the illustrated embodiment, the press mandrel 22 preferably includes a mandrel body 26, end caps 28, and screws 29. The mandrel body 26 comprises a generally cylindrical tube and presents opposite tube ends 30 and a cylindrical passage 32 that extends from one end 30 to the other end 30. The preferred cylindrical passage 32 defines an inner mandrel diameter dimension Di (see FIG. 2) that is substantially constant along the length of the mandrel 22, although alternative internal passage configurations are within the scope of the present invention. Each of the ends 30 presents threaded holes 34.

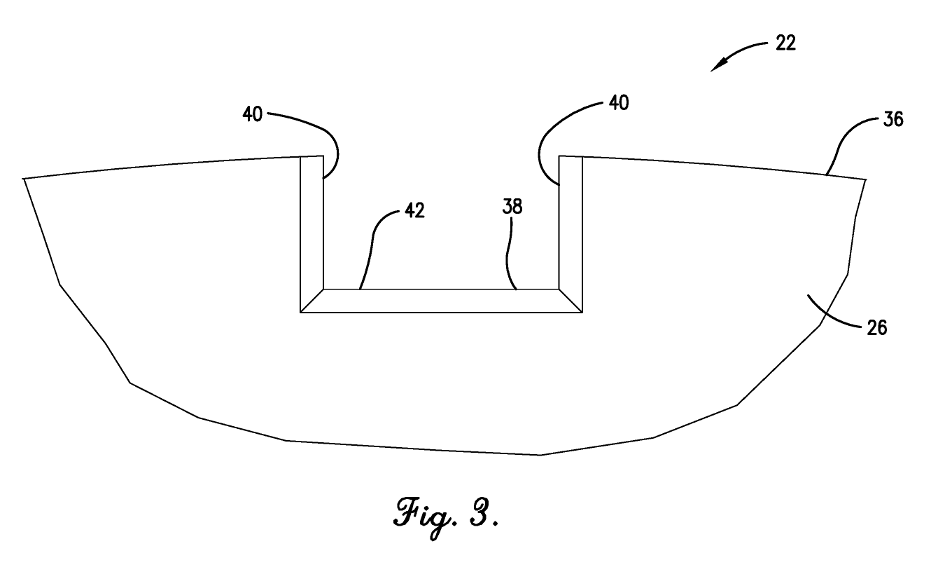

The mandrel body 26 also preferably presents a cylindrical outer receiving surface 36 and a longitudinal slot 38 (see FIG. 2). The outer receiving surface 36 defines an outer mandrel diameter dimension Do (see FIG. 2) that is substantially constant along the length of the mandrel 22. The slot 38 is defined by opposite side faces 40 and a bottom face 42 presented by the mandrel body 26, with the ends of the faces 40,42 being chamfered (see FIG. 3). The illustrated slot 38 preferably presents a generally rectangular cross-sectional shape, with side faces 40 being generally equal in cross-sectional dimension to one another but smaller than the bottom face 42. The slot 38 extends longitudinally along an axis Ap (see FIG. 1) of the press mandrel 22 and intersects the receiving surface 36. Preferably, the slot 38 presents an axis that is parallel to the axis Ap.

However, it is within the ambit of the present invention where the slot 38 is alternatively configured. For instance, the slot 38 could be alternatively sized and/or shaped. In some embodiments, a dimension of the slot 38 (e.g., the width and/or height dimension of the slot 38) could taper along the length of the slot 38. Also, the width and/or height dimension of the slot 38 could taper along the cross section of the slot 38. Yet further, the slot 38 could present an alternative length. The principles of the present invention are also applicable where the mandrel body 26 is devoid of the slot 38 or includes multiple slots 38 (e.g. where multiple slots 38 are spaced about the circumference of the mandrel body 26 to receive corresponding slides).

The illustrated end caps 28 serve to support the mandrel body 26. Each end cap 28 includes inboard and outboard tube sections 44 and 45, respectively, and a flange 46 that projects radially outwardly from the tube sections 44,45. The tube sections 44,45 each present an outer surface 47 that is substantially cylindrical. That is, the outer surfaces 47 each present a cap diameter dimension Dc that is substantially constant along the length of the tube sections 44,45, although the tube sections 44,45 may be alternatively configured, if desired.

Each end cap 28 also presents axial inner and outer ends and a longitudinal bore 48 (see FIG. 2). However, it is also within the scope of the present invention where end cap 28 does not include the bore 48. The flange 46 is spaced between the ends and presents counterbore holes 50 that extend through the flange 46 and are positioned about the tube sections 44. Although the end caps 28 are substantially the same, it is within the scope of the present invention where the end caps 28 are shaped or otherwise configured differently from one another.

The inboard tube section 44 of each end cap 28 is removably inserted into a corresponding tube end 30 of the mandrel body 26 so that the inner end of end cap 28 is positioned within the passage 32. Preferably, the cap diameter dimension Dc is smaller than the inner mandrel diameter dimension Di to permit the inboard section 44 of the end cap 28 to be inserted within the passage 32. The inboard section 44 of the end cap 28 is inserted into the passage 34 until the flange 46 contacts the corresponding tube end 32. Each end cap 28 is secured to the mandrel body 26 with screws 29 that are inserted through the holes 50 and threaded into corresponding threaded holes 34. In the usual manner, the press mandrel 22 is operable to be rotatably mounted on the rotary press so that the press mandrel 22 spins about the mandrel axis Ap. More particularly, the outboard section 45 of each end cap 28 is suitably supported on the press.

The end caps 28 each preferably include a hardened steel material. The end caps 28 may be formed entirely (or even partly) of hardened steel. However, the end caps 28 could include other metal materials, such as alloy steel or stainless steel. The mandrel body 26 preferably includes a carbon steel, but could include other metal materials, such as stainless steel.

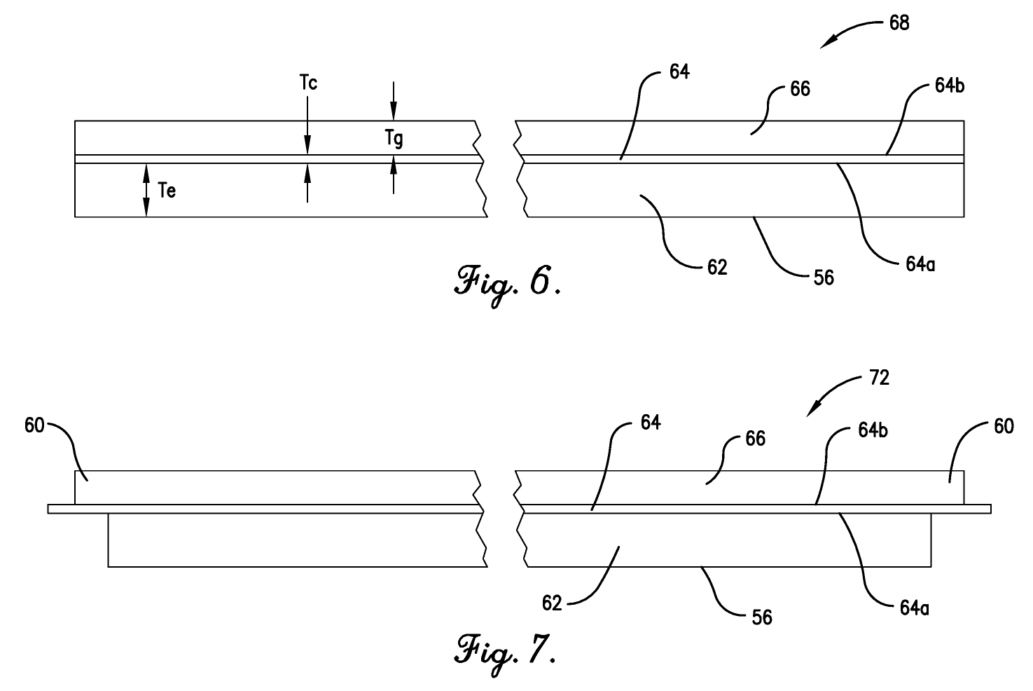

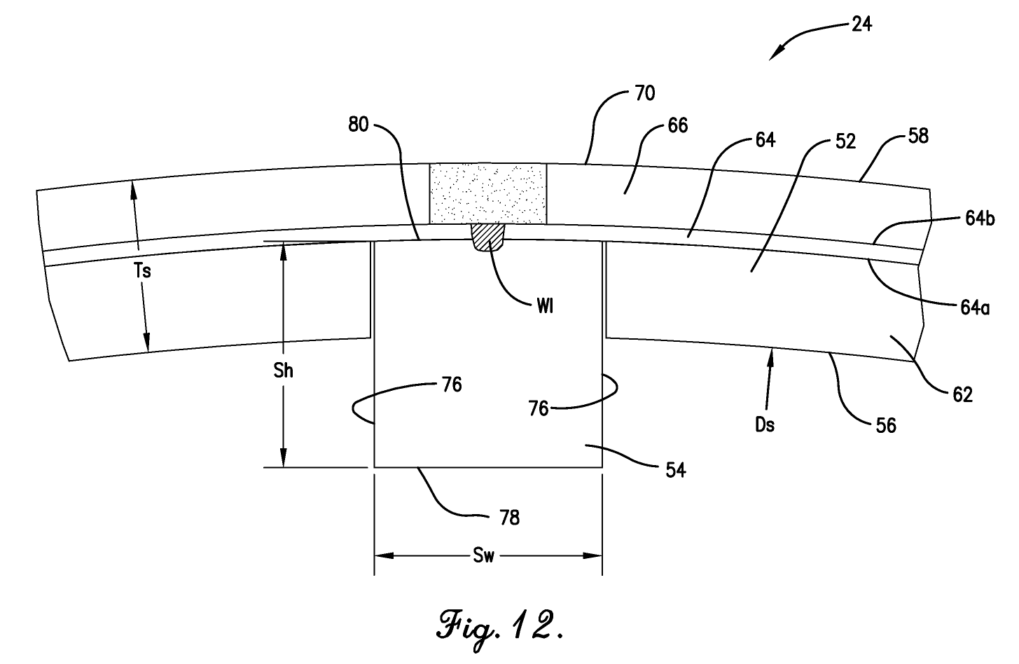

Turning to FIGS. 6-12, the rotary sleeve 24 is preferably configured to be secured on the press mandrel 22 via an interference fit. As will be explained, a sufficient temperature differential is preferably created between the rotary sleeve 24 and the mandrel body 26 so that the sleeve 24 slides onto the receiving surface 36. This is preferably accomplished by heating the sleeve 24 to a temperature higher than the body 26. The rotary sleeve 24 preferably includes a plate 52 and an elongated slide 54 that cooperatively present a unitary sleeve construction. The rotary sleeve 24 preferably presents inner and outer sleeve surfaces 56,58 (see FIGS. 2 and 12).

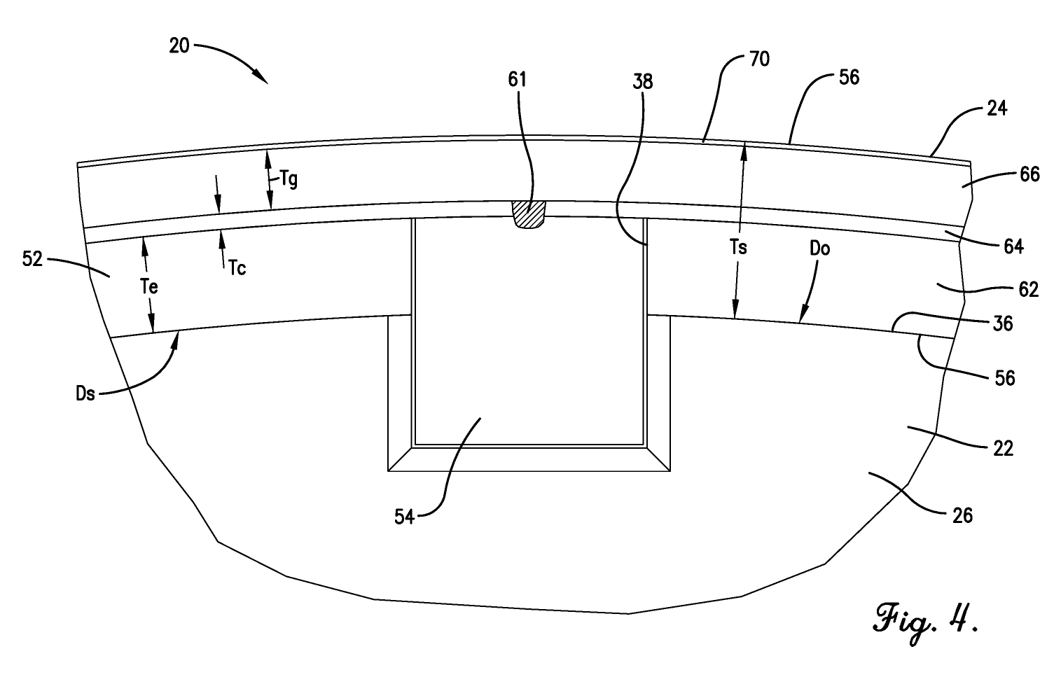

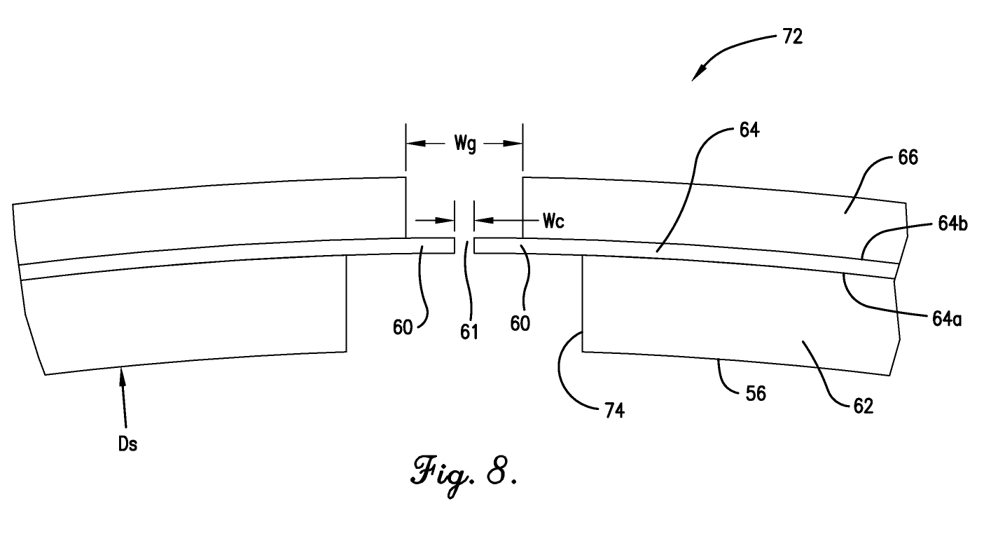

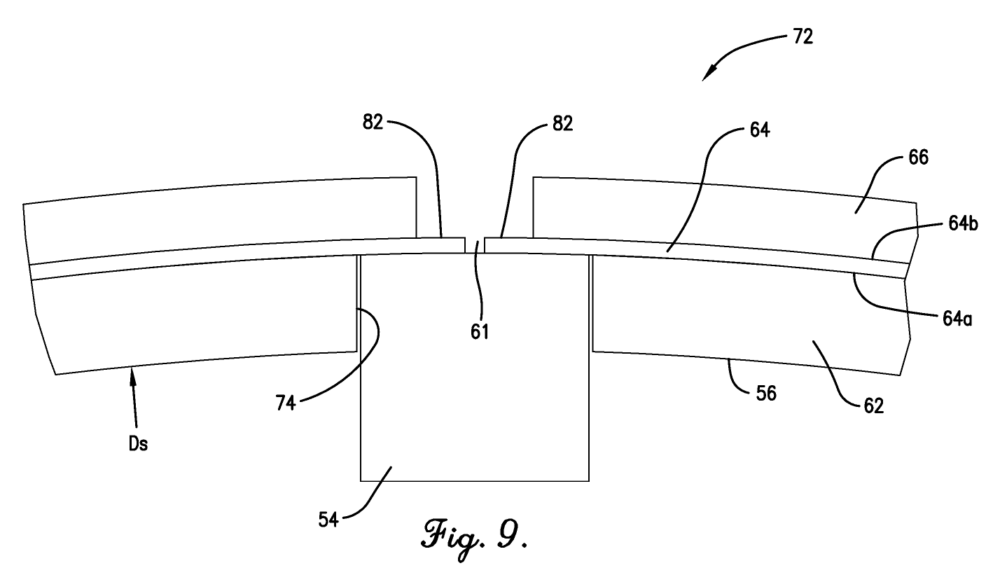

The plate 52 is preferably unitary, with the plate initially being flat and then curved into a cylindrical tubular shape that presents axially spaced ends 59 and defines a central sleeve axis As extending between the ends 59 (see FIG. 1). If desired, the plate 52 may be formed of a flexible material so as to prevent plastic deformation as the plate 52 is curved into the desired cylindrical shape. The plate 52 presents plate margins 60 which are positioned adjacent one another when the plate 52 is formed into a cylindrical shape (see FIG. 8). Once the plate 52 is formed into the cylindrical shape, it preferably generally maintains the sleeve shape in the absence of external forces (such as flexing forces). The inner sleeve surface 56 defines an inner sleeve diameter dimension Ds (see FIG. 4). Preferably, the plate margins 60 are positioned adjacent one another and cooperatively form a longitudinal seam 61 that extends along the length of the curved plate 52 (see FIGS. 8 and 9). As will be described, the illustrated margins 60 are fixed relative to one another, and the seam 61 is suitably filled so that the outer surface 58 is smooth and continuous.

Turning to FIGS. 6-12, the plate 52 is cooperatively formed by an underlying expansion layer 62, an intermediate, perforated, carrier layer 64 and an overlying engravable layer 66 (see FIGS. 8-10). These layers 62,64,66 are preferably provided in the form of flat sheets that are cladded to one another to form an integral, cladded flat plate 68 (see FIG. 6). As will be discussed, the rotary sleeve 24 may also include an outermost plated layer 70 (see FIG. 12), which is applied to the curved plate 52 after the curved plate 52 is welded to the slide 54 and the desired image is formed in the engravable layer 66. As used herein, the term “engraving” preferably refers to laser engraving, but could also refer to engraving by photo-etching, manual engraving, electromechanical engraving, or machining (e g , conventional milling). The expansion layer 62 presents the inner sleeve surface 56 and the plated layer 70 presents the outer sleeve surface 58.

The layers 62,64,66,70 of the curved plate 52 are preferably configured so that heating of the sleeve 24 to a temperature higher than the ambient temperature temporarily enlarges the sleeve 24. The sleeve 24 can then be cooled for securement to the mandrel 22 in an interference fit. During use in a hot foil stamping process, it will be understood that both the mandrel 22 and the sleeve 24 are heated after being secured to one another. However, the mandrel 22 and sleeve 24 remain suitably engaged with one another (e.g., through frictional interconnection between the mandrel 22 and sleeve 24 and/or engagement between slot 38 and slide 54) when heated during the hot foil stamping process.

To provide suitable expansion, the expansion layer 62 preferably includes a material with a greater coefficient of thermal expansion than the material used to form the carrier layer 64. In the illustrated embodiment, the expansion layer 62 preferably includes an aluminum alloy material and, more preferably, the expansion layer 62 comprises aluminum alloy 6061. The carrier layer 64 preferably includes a stainless steel alloy material and, more preferably, comprises an SAE 304 stainless steel material. The SAE 304 stainless steel material is substantially nonmagnetic.

However, it is within the scope of the present invention for the expansion layer 62 to include an additional or alternative metal material. For instance, the expansion layer 62 may be formed of an alternative aluminum alloy, or another suitable metal having a greater expansion rate than the carrier layer 64. Similarly, the carrier layer 64 may also be formed of an additional or alternative metal. For example, the carrier layer 62 may be formed of an alternative stainless steel alloy, a nonstainless steel alloy, or another suitable metal having a smaller rate of expansion than the expansion layer 62. Furthermore, the carrier layer 64 could comprise a magnetic metal material. As used herein, the term “magnetic” refers generally to ferrous materials that are either magnetized or capable of being magnetized.

The expansion layer 62 also preferably presents a thickness dimension Te greater than a thickness dimension Tc of the carrier layer 62 (see FIG. 6). The thickness dimension Te of the expansion layer 62 preferably ranges from about twenty-four thousandths of an inch (0.024″) to about sixty thousandths of an inch (0.060″) and, more preferably, is about forty-eight thousandths of an inch (0.048″). The thickness dimension Tc of the carrier layer 64 preferably ranges from about four thousandths of an inch (0.004″) to about twelve thousandths of an inch (0.012″) and, more preferably, is about eight thousandths of an inch (0.008″).

Preferably, the carrier layer 64 presents a pattern of perforations (not shown) that project through the carrier layer 64 from an inner surface 64a to an outer surface 64b. The perforations preferably have a uniform size and shape and are uniformly distributed along the length and width of the carrier layer 64. For each surface 64a,b, the perforations are preferably sized and distributed so that the percentage of the nonperforated area of the surface 64a,b to the total area of the surface 64a,b (including the perforations and the solid portion of the carrier layer 64) ranges from about twenty percent (20%) to about sixty percent (60%). More preferably, the ratio of the nonperforated area of the surface 64a,b to the total area of the surface 64a,b is about forty percent (40%). It will be appreciated that the perforations can be variously shaped and/or sized without departing from the scope of the present invention.

In the preferred embodiment, the relative layer thicknesses, the relative coefficients of expansion for the layers 62,64, and the perforations formed in the layer 62 cooperatively allow the sleeve 24 and press mandrel 22 to be selectively secured to and removed from each other by a sufficient temperature differential therebetween. In particular, the use of the relatively thicker expansion layer 62 overcomes the limited expansion of the carrier layer 64 and drives the overall dimension of the sleeve 24, e.g., when the sleeve 24 is heated to a sleeve expansion temperature for sleeve installation or sleeve removal (as will be described below). The materials selected for the expansion and carrier layers 62,64 and their respective coefficients of thermal expansion will also impact the construction of the plate. For example, with some suitable configurations, the expansion and carrier layers 62,64 may have the same thickness. It may also be possible with some configurations to eliminate the need for perforations.

In general, the preferred sleeve configuration preferably causes the carrier layer 64 to undergo elastic deformation when heated to the sleeve expansion temperature. In some instances, heating the sleeve 24 to the sleeve expansion temperature could stretch the carrier layer 64 beyond its yield point such that the carrier layer 64 undergoes plastic deformation. However, for at least some aspects of the present invention, such excessive deformation of the carrier layer 64 is not preferred. It will be appreciated that the layer thicknesses, the coefficients of expansion, and/or the carrier layer perforations could be alternatively configured without departing from the scope of the present invention.

The engravable layer 66 defines a thickness dimension Tg (see FIG. 6). Prior to being engraved, the thickness dimension Tg of the engravable layer 66 preferably ranges from about one thousandth of an inch (0.001″) to about forty thousandths of an inch (0.040″) and, more preferably, is about four thousandths of an inch (0.004″). The engraving that defines image indicia on the engravable layer 66 preferably has a depth that ranges from about three hundred-thousandths of an inch (0.00003″) to about thirty-five thousandths of an inch (0.035″). After being engraved, the engravable layer 66 preferably presents a minimum thickness dimension (generally along the engraved area forming the image indicia) that ranges from about five ten-thousandths of an inch (0.0005″) to about five thousandths of an inch (0.005″).

The total sleeve thickness dimension Ts (see FIG. 12), including the plated layer 70, preferably ranges from about twenty thousandths of an inch (0.020″) to about eighty thousandths of an inch (0.080″) and, more preferably is about sixty thousandths of an inch (0.060″).

The engravable layer 66 preferably comprises a material that is relatively softer than the carrier layer 64 (such as a nonferrous alloy). More preferably, the engravable layer 66 comprises a copper material, but could include an alternative metal material (e.g., another nonferrous alloy, such as magnesium, bronze, etc.) without departing from the scope of the present invention. Suitable alternative materials include bronze and magnesium.

The plated layer 70 preferably includes a nickel or chrome material, but could include an alternative material for suitably covering the engraved surface of the engravable layer 66. The plated layer 70 is preferably applied to the engravable layer 66 after the layer 66 is engraved.

Again, the layers 62,64,66 in the form of flat sheets are preferably cladded to one another to form the cladded flat plate 68 (see FIG. 6). More specifically, the expansion layer 62 and the engravable layer 66 are preferably cladded to opposite inner and outer surfaces 64a,b of the carrier layer 64 using suitable cladding techniques (see FIG. 6). The plated layer 70 is applied to the engravable layer 66 using a conventional plating process.

Prior to being formed into a cylinder, portions of the expansion layer 62 and the engravable layer 66 along the end margins 60 are preferably removed before forming the flat plate into a cylinder (see FIG. 7). The flat plate is then formed around a build mandrel (not shown) to produce an intermediate or machined form of the plate, which is referenced herein by numeral 72 (see FIG. 8). As will be discussed, endmost portions of the expansion layer 62 are preferably removed so that the end margins 60 form a channel that receives the slide 54. Also, endmost portions of the engravable layer 66 are preferably removed to facilitate attachment of the machined plate 72 to the slide 54.

Turning to FIGS. 8-10, the machined plate 72 is preferably formed around a build mandrel (not shown). The formed plate 72 is then welded to the slide 54 to form the sleeve 24. Preferably, forming of the machined plate 72 around the build mandrel is completed before either end margin 60 is welded. However, one margin 60 of the machined plate 72 could be at least partly welded to the slide 54 prior to curving the machined plate 72 around the mandrel. To provide the interference fit between the press mandrel 22 and rotary sleeve 24, the build mandrel preferably presents an outer diameter dimension that is slightly smaller than the outer mandrel diameter dimension Do of the press mandrel 22. However, it will be appreciated that the build mandrel could be alternatively configured to vary the process by which the machined plate 72 is formed or the configuration of the sleeve 24 once it is fully formed. Also, for some aspects of the present invention, the press mandrel 22 could be used as the build mandrel.

The machined plate 72 is preferably formed around the build mandrel to assume a substantially continuous cylindrical shape (see FIG. 8). Again, the machined plate 72 is curved around the build mandrel so that the margins 60 are located adjacent to one another and cooperatively form the longitudinal seam 61 that extends axially along the sleeve 24 (see FIGS. 8 and 9). Along the illustrated seam 61, the margins 60 of the carrier layer 64 preferably cooperatively define a gap that presents a carrier layer gap dimension Wc (see FIG. 8). The carrier layer gap dimension Wc preferably ranges from about zero inches (0.000″) to about ten thousandths of an inch (0.010″).

Also, the margins 60 of the engravable layer 66 preferably cooperatively define a gap that presents an engravable layer gap dimension Wg (see FIG. 8). The engravable layer gap dimension Wg preferably ranges from about forty thousandths of an inch (0.040″) to about eighty thousandths of an inch (0.080″). As will be discussed, the gap in the engravable layer 66 is preferably filled after the carrier layer 64 is welded to the slide 54.

The margins 60 also cooperatively define a longitudinal channel 74 to receive the slide 54 (see FIG. 9). The illustrated channel 74 preferably presents a cross-sectional shape that is substantially continuous along the length of the sleeve 24. The channel 74 is formed so that the slide 54 can be positioned in direct engagement with and fixed directly to the carrier layer 64. Preferably, the slide 54 is welded to the carrier layer 64. However, the slide 54 and carrier layer 64 could be otherwise fixed to one another (e.g., by being integrally formed). In the illustrated embodiment, the channel 74 is formed by removing the endmost portions of the expansion layer 62. However, it will be appreciated that the channel 74 could be alternatively formed to permit direct engagement between the slide 54 and the carrier layer 64. For instance, the expansion layer 62 could be shorter than the carrier layer 64 prior to cladding of the layers 62,64 to one another.

It will be appreciated that the slide 54 could be fixed directly to the expansion layer 62 (e.g., by welding the slide 54 to the expansion layer 62). For instance, the slide 54 could be welded to the inner sleeve surface 56 without removing the endmost portions of the expansion layer 62.

Furthermore, the channel 74 could alternatively be formed to allow the slide 54 to be fixed directly to the engravable layer 66 (e.g., by welding the slide 54 to the engravable layer 66). For instance, to fix the slide 54 to the engravable layer 66, the channel 74 could be formed by removing endmost portions of the expansion layer 62 and of the carrier layer 64 so as to expose the underside of the engravable layer 66. In this alternative configuration, the slide is preferably formed of the same material as the engravable layer 66.

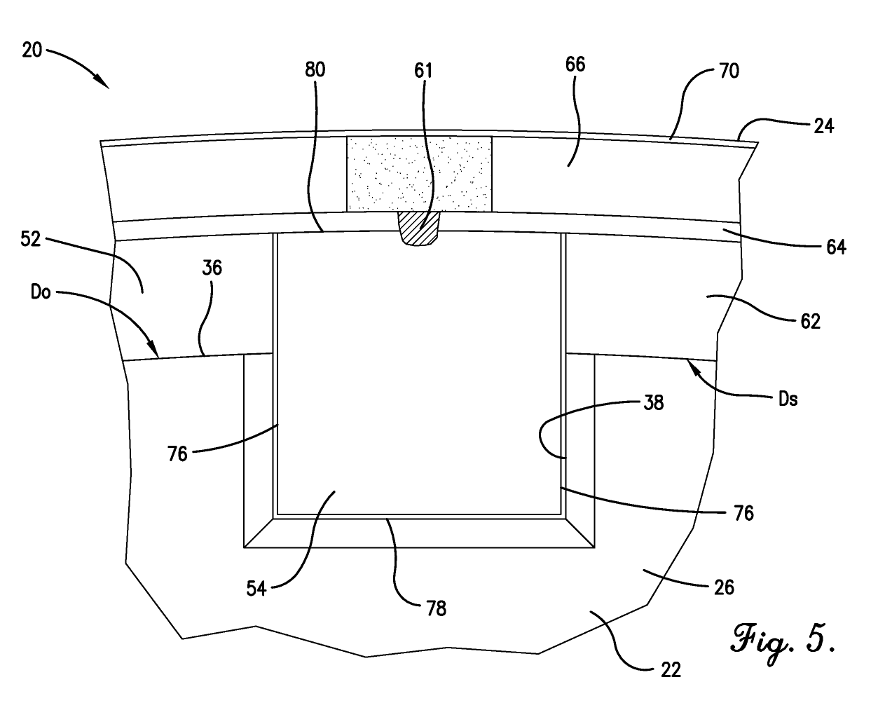

The illustrated slide 54 comprises a unitary rod that presents side surfaces 76, a bottom surface 78, and a top surface 80 (see FIGS. 5 and 12). The side surfaces 76 are preferably planar and parallel to one another. The bottom surface 78 is also preferably planar and extends orthogonally to the side surfaces 76.

The top surface 80 is preferably a substantially planar surface that is positionable alongside the inner surface 64a. However, the top surface 80 could have a convex shape (e.g., where the top surface 80 presents the same radius as the inner surface 64a so that the slide 54 and the carrier layer 64 conform to one another prior to being welded together). However, the sleeve 24 could be alternatively configured to provide conforming engagement. For instance, the inner surface 64a could include flat surface sections along the margins 60 that engage corresponding planar top surfaces of the slide 54.

The slide 54 preferably presents a height dimension Sh and a width dimension Sw (see FIG. 12). The dimensions Sh,Sw are preferably the same and range from about one hundred thousandths of an inch (0.100″) to about two hundred fifty thousandths of an inch (0.250″). The slide 54 preferably includes an alloy steel material, but could include other materials. In the illustrated embodiment, the material of the slide 54 preferably matches the material of the carrier layer 64.

However, it is within the ambit of the present invention where the slide 54 is alternatively configured. For instance, the slide 54 could be alternatively sized and/or shaped. In some embodiments, a dimension of the slide 54 (e.g., the width and/or height dimension of the slide 54) could taper along the length of the slide 54. Yet further, the slide 54 could present an alternative length. It will also be appreciated that the assembly 20 could be devoid of the slide 54 or could include multiple slides 54 (e.g. where multiple slides 54 are spaced along the circumference of the curved plate 52). Furthermore, the assembly 20 could include multiple spaced apart slide segments, all of which are received within the slot 38.

The illustrated slide 54 preferably projects radially inwardly relative to the inner sleeve surface 56. In this manner, the slide 54 is located to engage the slot 38 of the press mandrel 22 to restrict relative rotation between the press mandrel 22 and the sleeve 24. However, for some aspects of the present invention, the bottom surface 78 of the slide 54 could be substantially flush with the inner sleeve surface 56 or spaced radially outwardly from the inner sleeve surface 56 (e.g., where the interference fit between the press mandrel 22 and the sleeve 24 is sufficient to restrict relative rotation therebetween).

The curved plate 52 and slide 54 are welded to one another so that the rotary sleeve 24 has a unitary construction and presents the inner sleeve diameter dimension Ds. Furthermore, the rotary sleeve 24 is preferably constructed to be mounted on the press mandrel 22 with an interference fit when the assembly 20 is at the press operating temperature. For printing, embossing, debossing, and texturing, the press preferably operates at room temperature. Those of ordinary skill in the art will appreciate that the illustrated sleeve 24 is particularly suitable for the foregoing non-heated applications. However, for an operation that includes hot foil stamping of the substrate, the press preferably operates at a temperature above room temperature. The rotary sleeve 24 is sized so that the inner sleeve diameter dimension Ds is equal to or slightly undersized relative to the outer mandrel diameter dimension Do. Preferably, the difference of the outer mandrel diameter dimension Do minus the inner sleeve diameter dimension Ds (Do-Ds) preferably ranges from about zero inches (0.0000″) to about fifteen ten-thousandths of an inch (0.0015″) when the rotary sleeve 24 and the press mandrel 22 are at room temperature. As used herein, room temperature refers to an ambient temperature that ranges from about fifty degrees Fahrenheit (50° F.) to about eighty-five degrees Fahrenheit (85° F.) and, more preferably, ranges from about seventy degrees Fahrenheit (70° F.) to about seventy-five degrees Fahrenheit (75° F.). As will be discussed, a temperature differential is preferably created between the rotary sleeve 24 and the press mandrel 22 to permit the rotary sleeve 24 to be mounted onto the press mandrel 22. The sleeve 24 is preferably heated relative to the press mandrel 22, although it is within the ambit of the present invention where the press mandrel 22 is cooled to permit mounting of the sleeve 24 onto the press mandrel 22.

It is also possible with some alternative assembly configurations for both the mandrel 22 and the sleeve 24 to be heated or cooled to the same degree. For instance, different rates of expansion or contraction of the sleeve 24 and the mandrel body 26 could provide enough of a variance between the outer diameter of the mandrel 22 and the inner surface of the sleeve 24 to allow for mounting or removal. Furthermore, if the illustrated assembly 20 is used for hot foil stamping, the desired interference fit is preferably maintained when the assembly 20 is heated during hot foil stamping operations.

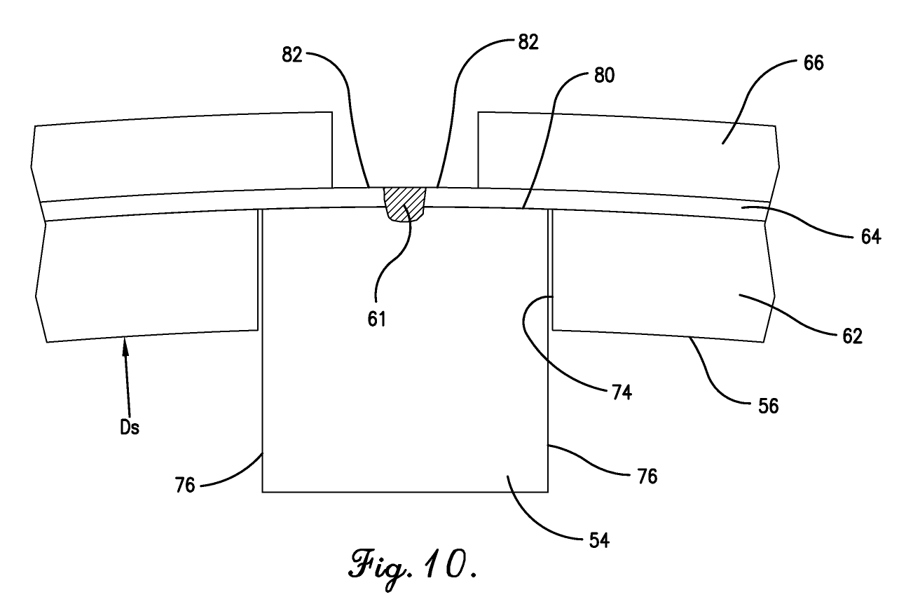

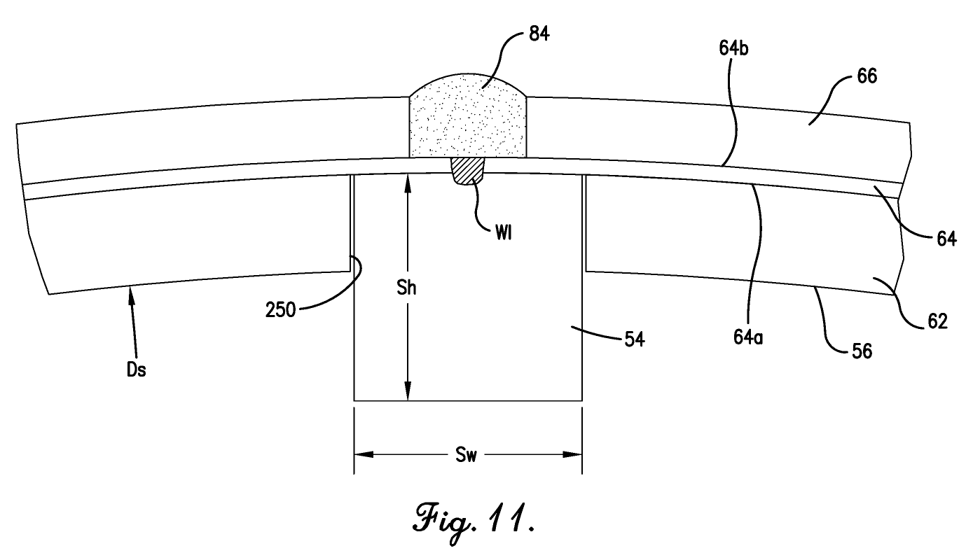

The plate 52 and slide 54 are preferably welded to one another while mounted on the build mandrel so that the rotary sleeve 24 has a unitary construction. Preferably, the plate 52 and slide 54 are welded together by two separate welding passes using a welding process. In a first welding pass, the carrier layer 64 is welded to the slide 54 by a weld bead W1 that extends along weld zones 82 associated with the margins 60 (see FIGS. 10 and 11). That is, the margins 60 are each fixed to the slide 54 and, consequently, the margins 60 are fixed relative to one another. The first welding pass is preferably done by laser welding, although other types of welding could be used. As used herein, the term “weld zone” generally refers to the area in which material becomes temporarily liquified during the welding process.

In a second welding pass, a bead 84 of material is applied within the gap of the seam 61 (see FIG. 11). The bead 84 of weld material deposited during the second welding pass preferably includes a copper material (although the weld material could include another nonferrous material, such as tin, nickel, etc.). The bead 84 is preferably deposited as a filler material to fill the seam 61 so that the outer surface can subsequently be made smooth and continuous across the seam 61. Furthermore, the weld material is deposited so that the seam 61 is filled with the weld material and an excess amount of weld material is also deposited above the seam 61 to form a generally convex bead 84 that projects radially outwardly from the margins 60 of the engravable layer 66 (see FIG. 11).

In the illustrated embodiment, the bead 84 of material applied during the second welding pass is preferably applied using a laser welding process. It is also within the scope of the present invention where an alternative welding process is used for the second welding pass, such as TIG welding or brazing. As a result of this second welding pass, the engravable layer 66 is welded so that the bead 84 of material joins the margins 60 of the engravable layer 66. However, the principles of the present invention are equally applicable where the bead 84 of material applied by the second welding pass does not weld the margins 60 of the engravable layer 66 to each other.

The second welding pass is preferably performed once the first welding pass has been completed along the seam 61. While a welding process is preferred for performing both welding passes, the principles of the present invention are applicable to weld at least part of the seam 61 using an alternative process. For instance, in the event that the bead 84 does not weld the margins 60 of the engravable layer 66 to one another, other material deposition processes could be used to apply the bead 84 so that the bead 84 operates to fill the seam 61, such as a soldering process. While not preferred, the plate 52 and slide 54 could be at least partly secured to one another with adhesive and/or mechanical fasteners.

Once the welding processes are complete, excess portions of the bead 84 are preferably removed by grinding the bead 84 down to the finished outer diameter of the engravable layer 66 (see FIG. 12). The illustrated sleeve preferably remains mounted on the build mandrel while excess weld material is removed. However, in another preferred embodiment, the sleeve could be mounted on a second build mandrel (not shown) for supporting the sleeve while excess weld material is being removed. Preferably, the bead 84 is removed so that the outermost surface of the curved plate 52 has a continuous radius and is smooth across the seam 61 from one of the margins 60 to the other one of the margins 60.

The engravable layer 66 is preferably then engraved to produce an engraved surface that defines image indicia 86 (see FIG. 1). As discussed, the engraved features of the engraved surface are preferably formed by laser engraving, but other conventional engraving techniques can be used to form the engraved surface (such as photo-etching, electromechanical engraving, manual engraving, or machining) Because the seam 61 is filled, the image indicia 86 can extend across the seam 61, although such positioning of the indicia 86 is not required. For some aspects of the present invention, the layer 66 could also be engraved while the plate 52 is flat (i.e., before it is formed into the cylindrical sleeve).

With the engraved surface completed, the plated layer 70 can then be applied to cover the engravable layer 66 (see FIG. 4). Again, the plated layer 70 preferably includes a nickel or chrome material, but could include an alternative material for covering the engraved surface with a suitably hard, non-stick, and wear-resistant covering. Preferably, the outer sleeve surface 58 presented by the plated layer 70 has a continuous radius and is smooth across the seam 61 (at least along surface locations outside the image indicia 86). However, it is within the ambit of the present invention where the sleeve does not include the plated layer 70. For instance, the outer sleeve surface 58 could be presented by the engravable layer 66.

To secure the rotary sleeve 24 onto the press mandrel 22, the rotary sleeve 24 is preferably heated above the temperature of the press mandrel 22 to permit the rotary sleeve 24 to be mounted onto the press mandrel 22. More specifically, the sleeve 24 is heated relative to the press mandrel 22 to the sleeve expansion temperature so that the inner sleeve diameter dimension Ds is greater than the outer mandrel diameter dimension Do. The sleeve expansion temperature preferably ranges from about one hundred eighty degrees Fahrenheit (180° F.) to about four hundred degrees Fahrenheit (400° F.), while the press mandrel 22 is maintained at or about the ambient temperature. When heated to the sleeve expansion temperature for sleeve installation, the carrier layer 64 preferably undergoes elastic deformation. With the rotary sleeve 24 heated, the rotary sleeve 24 can slide over and onto the press mandrel 22, with the slide 54 received in the slot 38.

However, for some aspects of the present invention, the press mandrel 22 could be cooled to a temperature below the ambient temperature to reduce the outer mandrel diameter dimension Do. Such cooling of the press mandrel 22 could be done as an alternative to heating of the rotary sleeve 24 or in combination with heating of the rotary sleeve 24.

As discussed above, it has been found that the relative layer thicknesses, the relative coefficients of expansion for the layers 62,64, and the perforations formed in the layer 62 cooperatively allow the sleeve 24 and press mandrel 22 to be selectively secured and removed from each other by heating the sleeve 24. In particular, the use of the relatively thicker expansion layer 62 overcomes the limited expansion of the carrier layer 64 and drives the overall expansion of the sleeve 24 when the sleeve 24 is heated to the sleeve expansion temperature. Again, for sleeve installation, the preferred sleeve configuration preferably causes the carrier layer 64 to undergo elastic deformation when heated to the sleeve expansion temperature.

The layers 62,64,66,70 cooperatively provide an overall thermal expansion coefficient of the sleeve 24, with thermal expansion of the illustrated sleeve 24 being driven mostly by the expansion layer 62. Again, the expansion layer 62 preferably includes an aluminum alloy material that is different than the material of the press mandrel 22 (i.e., so that the expansion layer 62 has a greater coefficient of thermal expansion than the press mandrel 22). Furthermore, the overall thermal expansion coefficient of the sleeve 24 (cooperatively provided by the illustrated layers 62,64,66,70) is preferably greater than the thermal expansion coefficient of the press mandrel 22. Consequently, when the sleeve 24 is mounted to the press mandrel 22, both can be heated together to permit the sleeve 24 to be slidably removed from the press mandrel 22.

The rotary sleeve 24 is preferably selectively removable from the press mandrel 22. Preferably, the sleeve 24 and the press mandrel 22 are both heated to a temperature above ambient so that the inner sleeve diameter dimension Ds is about equal to or greater than the outer mandrel diameter dimension Do. In particular, the sleeve 24 and the press mandrel 22 are heated to a sleeve expansion temperature that preferably ranges from about four hundred fifty degrees Fahrenheit (450° F.) to about five hundred fifty degrees Fahrenheit (550° F.). Because the overall thermal expansion coefficient of the sleeve 24 is greater than the thermal expansion coefficient of the press mandrel 22, the press mandrel 22 and sleeve 24 can be heated together so that the sleeve 24 is capable of being slid off of the mandrel 22. It is also within the scope of the present invention where the press mandrel and sleeve 24 are heated during sleeve removal so that the temperature of the press mandrel 22 is generally above the ambient temperature (due to heat conduction from the sleeve 24 to the press mandrel 22), but at a temperature below the sleeve expansion temperature. Furthermore, the press mandrel 22 could also be cooled to a temperature at or below the ambient temperature to reduce the outer mandrel diameter dimension Dm. Again, such cooling of the press mandrel 22 could be done as an alternative to heating of the rotary sleeve 24 or in combination with heating of the rotary sleeve 24.

When heated to the sleeve expansion temperature for removal of the sleeve 24, the carrier layer 64 preferably undergoes plastic deformation, such that the carrier layer 64 is stretched beyond its yield point. However, heating the sleeve 24 to the sleeve expansion temperature for sleeve removal could stretch the carrier layer 64 to a condition short of its yield point such that the carrier layer 64 undergoes elastic deformation. For instance, if the operator does not intend to reuse the sleeve 24, the sleeve 24 could be heated to permanently stretch the carrier layer 64. However, if the sleeve 24 is to be reused after removal, the sleeve 24 is preferably not heated to the extent that the carrier layer 64 is permanently deformed.

Although the above description presents features of preferred embodiments of the present invention, other preferred embodiments may also be created in keeping with the principles of the invention. Such other preferred embodiments may, for instance, be provided with features drawn from one or more of the embodiments described above. Yet further, such other preferred embodiments may include features from multiple embodiments described above, particularly where such features are compatible for use together despite having been presented independently as part of separate embodiments in the above description.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A graphic arts sleeve operable to be removably mounted on a rotatable mandrel and to texture, print, and/or hot foil stamp on a substrate, said graphic arts sleeve comprising:
a cylindrical plate presenting an outermost sleeve surface operable to engage and thereby texture, print, and/or hot foil stamp on the substrate,
said cylindrical plate presenting an innermost support surface opposite the outermost sleeve surface and operable to engage the mandrel,
said cylindrical plate including an intermediate carrier layer and an overlying engravable layer cladded to and supported by the carrier layer,
said cylindrical plate further including an underlying expansion layer cladded to the carrier layer,
said expansion layer having a greater coefficient of thermal expansion than the carrier layer, with heating of at least the expansion layer causing diametrical expansion of the innermost support surface to facilitate mounting or removal of the cylindrical plate relative to the mandrel.

2. The graphic arts sleeve as claimed in claim 1,
said cylindrical plate presenting opposite axially spaced ends; and
an axially extending slide fixed to the plate.

3. The graphic arts sleeve as claimed in claim 2,
said slide extending continuously from one end of the plate to the other.

4. The graphic arts sleeve as claimed in claim 2,
said cylindrical plate presenting opposed end margins that cooperatively form a longitudinal seam,
said slide extending along the seam and being fixed to the plate radially inward of the engravable layer.

5. The graphic arts sleeve as claimed in claim 4,
said slide spanning the seam.

6. The graphic arts sleeve as claimed in claim 2,
said slide being formed at least substantially of the same material as the carrier layer.

7. The graphic arts sleeve as claimed in claim 6,
said slide being welded to the carrier layer.

8. The graphic arts sleeve as claimed in claim 2,
each of said layers having opposed end margins that cooperatively form a longitudinal seam,
said end margins of the expansion layer being spaced further apart than the end margins of the carrier layer so as to define a channel,
said slide being received in the channel.

9. The graphic arts sleeve as claimed in claim 8,
said carrier layer presenting an inner surface that directly engages the slide.

10. The graphic arts sleeve as claimed in claim 9,
said slide being welded to the carrier layer.

11. The graphic arts sleeve as claimed in claim 10, further comprising:
a filler located at least partly within the seam to bridge the end margins of the engravable layer,
said engravable layer and said filler cooperatively providing an outer sleeve surface, with at least part of the outer sleeve surface being continuous across the seam from one end margin to the other end margin.

12. The graphic arts sleeve as claimed in claim 11,
said outer sleeve surface being continuous.

13. The graphic arts sleeve as claimed in claim 11,
said engravable layer and filler comprising copper,
said carrier layer and sleeve comprising stainless steel,
said expansion layer comprising an aluminum alloy.

14. The graphic arts sleeve as claimed in claim 1,
said engravable layer comprising copper,
said carrier layer comprising stainless steel,
said expansion layer comprising an aluminum alloy.

15. The graphic arts sleeve as claimed in claim 1,
said cylindrical plate presenting opposed end margins that cooperatively form a longitudinal seam; and
a filler located at least partly within the seam to bridge the end margins of the engravable layer,
said engravable layer and said filler cooperatively providing an outer sleeve surface, with at least part of the outer sleeve surface being continuous across the seam from one end margin to the other end margin.

16. The graphic arts sleeve as claimed in claim 1,
said carrier layer being perforated.

17. The graphic arts sleeve as claimed in claim 16,
said carrier layer presenting opposite inner and outer surfaces,
said carrier layer having perforations extending between the surfaces,
each of said surfaces presenting a non-perforated surface area, which is measured outside the perforations, and a total surface area, which includes both the non-perforated surface area and the perforations,
said non-perforated surface area being about 20% to about 60% of the total surface area.

18. The graphic arts sleeve as claimed in claim 17,
said perforations being uniformly shaped, sized, and distributed.

19. The graphic arts sleeve as claimed in claim 18,
said expansion layer being radially thicker than the carrier layer.

20. The graphic arts sleeve as claimed in claim 16,
said carrier layer presenting opposite inner and outer surfaces,
said carrier layer having perforations extending between the surfaces,
said perforations being uniformly shaped, sized, and distributed.

21. The graphic arts sleeve as claimed in claim 16,
said expansion layer being radially thicker than the carrier layer.

22. The graphic arts sleeve as claimed in claim 21,
said engravable layer comprising copper,
said carrier layer comprising stainless steel,
said expansion layer comprising an aluminum alloy.

23. The graphic arts sleeve as claimed in claim 1,
said expansion layer being radially thicker than the carrier layer.

24. The graphic arts sleeve as claimed in claim 23,
said expansion layer presenting an expansion layer radial thickness,
said carrier layer presenting a carrier layer radial thickness,
said expansion layer radial thickness being about two to about fifteen times greater than the carrier layer radial thickness.

25. The graphic arts sleeve as claimed in claim 24,
said expansion layer radial thickness being about forty-eight thousandths of an inch,
said carrier layer radial thickness being about eight thousandths of an inch.

26. The graphic arts sleeve as claimed in claim 23,
said carrier layer comprising stainless steel,
said expansion layer comprising an aluminum alloy.
